(19) United States
(12) Patent Application Publication
(10) Pub. No.: US 2024/0169421 A1
(43) Pub. Date: May 23, 2024

(54) ONLINE BIDDING SYSTEM AND METHOD FOR SELLING PRODUCTS WITH OPEN AND HIDDEN BIDS

(71) Applicant: Mallikarjunarao KODIDALA, Hyderabad (IN)

(72) Inventor: Mallikarjunarao KODIDALA, Hyderabad (IN)

(21) Appl. No.: 18/280,230

(22) PCT Filed: Mar. 16, 2022
(86) PCT No.: PCT/IB2022/052357

§ 371 Date: Sep. 3, 2023

(30) Foreign Application Priority Data
Mar. 17, 2021 (IN) 202141011412

(51) Int. Cl. G06Q 30/08; G06Q 30/0601

(52) U.S. Cl. CPC G06Q 30/08; G06Q 30/0641

(57) ABSTRACT

An e-commerce system for selling products with open and hidden bids is disclosed. The system is configured to receive products and/services for bidding from sellers. The system is configured to display products received from the sellers for buyers to place bids in open and/or hidden mode, wherein the open bid amounts from buyers will be made visible to all the buyers participating in the bid, and hidden bid amounts are not visible to other buyers; and the system is configured to allow the seller to initiate a final call communicating the highest bid amount received so far from both open and hidden bids received, so that the buyers are allowed to increase their bid value before bid close. Displaying of highest bid amount to all buyers saves sellers time and gets a best price. Open and hidden bidding process get high prices to a product and benefits to seller. Also, open and hidden process avoids negotiation, if a person is selling product in non-bidding process.

### TECHNICAL FIELD OF THE INVENTION

The present invention generally relates to online bidding systems and methods, and more particularly to an improved online bidding system and method for selling products with open and hidden bids.

### BACKGROUND OF THE INVENTION

Systems and methods for purchasing have expanded to the internet very fast and very recently. Much of the growth in the e-commerce sector has been triggered by increasing use of internet and smartphone penetration. There are a number of online sites that specialize in auctioning and bidding. However, these sites typically are based on direct bidding by the buyer. However, a problem with most of these sites is that they all require a great deal of involvement from the buyer. Many of these websites simply collect customer names, phone numbers and information on products and services they are interested. After such information is collected, these websites simply send the information to sellers. Such processes are not much different from a customer calling or going to sellers.

All of the above indicates that there is a need for improved systems and methods for vehicle purchase that are reliable, cost effective, and that provide improved online bidding system and method for selling products with open and hidden bids.

### BRIEF SUMMARY OF THE INVENTION

According to an aspect of the present invention, an e-commerce system for selling products with open and hidden bids is disclosed. The system comprises a web server to which sellers and buyers makes an access, thus performing access management. The system also comprises a database storing data of functions required for bidding of products, and thereafter concluding a sale. The system further comprises an application server to establish functions for the bidding by using the stored data.

In accordance with the aspect of the present invention, the system is configured to receive products for bidding from the sellers in open and/or hidden mode.

In accordance with the aspect of the present invention, the system is configured to display products received from the sellers for buyers to place bids in open and/or hidden mode, wherein the open bid amounts from buyers will be made visible to all the buyers participating in the bid, and hidden bid amounts are not visible to other buyers.

In accordance with the aspect of the present invention, the system is configured to allow the seller to initiate a final call communicating the highest bid amount received so far from both open and hidden bids received, so that the buyers are allowed to increase their bid value before bid close.

In accordance with the aspect of the present invention, the buyers compete for a predetermined time established by the seller.

In accordance with the aspect of the present invention, the system receives data from the seller for his listed product, the data includes product description and a bid evaluation data including a desired price and proximity to a location.

In accordance with the aspect of the present invention, the system determines one winning bid at the bidding close based on the matching desired price and proximity.

According to another aspect of the present invention, a method of selling products with open and hidden bids on an e-commerce system is disclosed.

In accordance with the aspect of the present invention, the method comprises a step of providing a web server to which sellers and buyers makes an access, thus performing access management. The method comprises another step of providing a database for storing data of functions required for bidding of products, and thereafter concluding a sale. The method comprises one more step of providing an application server to establish functions for the bidding by using the stored data. The method comprises yet another step of receiving products for bidding from the sellers in open and/or hidden mode.

In accordance with the aspect of the present invention, the method comprises another step of displaying products received from the sellers for buyers to place bids in open and/or hidden mode, wherein the open bid amounts from buyers will be made visible to all the buyers participating in the bid, and hidden bid amounts are not visible to other buyers.

In accordance with the aspect of the present invention, the method comprises another step of allowing the seller to initiate a final call communicating the highest bid amount received so far from both open and hidden bids received, so that the buyers are allowed to increase their bid value before bid close.

Still other aspects, features, and advantages of the present invention are readily apparent from the following detailed description, simply by illustrating a number of exemplary embodiments and implementations, including the best mode contemplated for carrying out the present invention.

The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The invention will be further understood from the following detailed description of a preferred embodiment taken in conjunction with an appended drawing, in which:

FIG. 1 illustrates web application architecture of an e-commerce system for selling products, in accordance with the exemplary embodiment of the present invention;

FIG. 1a illustrates a block diagram depicting buyers place their bids either in open or hidden for a product/service, in accordance with the exemplary embodiment of the present invention;

FIG. 2 illustrates a buyer choosing bid type from bid type drop down box, in accordance with the exemplary embodiment of the present invention;

FIG. 3 illustrates buyer can enter the amount for the product and post a bid, in accordance with the exemplary embodiment of the present invention;

FIG. 4 illustrates a scenario where a seller posted a car for selling and hasn't received any bids, in accordance with the exemplary embodiment of the present invention;

FIG. 5 illustrates buyer 1 posted an open bid, in accordance with the exemplary embodiment of the present invention;

FIG. 6 illustrates buyer 2 posted an open bid, in accordance with the exemplary embodiment of the present invention;

FIG. 7 illustrates buyer 3 posted an open bid, in accordance with the exemplary embodiment of the present invention;

FIG. 8 illustrates buyer 1 posted a hidden bid, in accordance with the exemplary embodiment of the present invention;

FIG. 9 illustrates the systems component where the buyer 2 posts a hidden bid, in accordance with the exemplary embodiment of the present invention;

FIG. 10 illustrates the systems component where the buyer 3 posted a hidden bid, in accordance with the exemplary embodiment of the present invention;

FIG. 11 illustrates the systems component where the seller can see all buyer's actual usernames and bid usernames without masking of bid types, in accordance with the exemplary embodiment of the present invention;

FIG. 12 illustrates the systems component where seller initiates a ‘Final Call’ on receiving an expected amount, where a mobile message to all the buyers is sent so that interested buyers may send final bids.

FIG. 13 illustrates the systems component displaying “After Final Call” screen with final call bids, in accordance with the exemplary embodiment of the present invention;

FIG. 14 illustrates the systems component where bid usernames are automatically generated with algorithm for every product to avoid syndication between buyers.

### DETAILED DESCRIPTION OF THE INVENTION

The description that follows is presented to enable one skilled in the art to make and use the present invention and is provided in the context of a particular application and its requirements. Various modifications to the disclosed embodiments will be apparent to those skilled in the art, and the general principles discussed below may be applied to other embodiments and applications without departing from the scope and spirit of the invention. Therefore, the invention is not intended to be limited to the embodiments disclosed, but the invention is to be given the largest possible scope which is consistent with the principles and features described herein.

The terminology used herein is to describe particular example embodiments only and is not intended to be limiting. As used herein, the singular forms “a,” “an” and “the” “said” may be intended to include the plural forms as well, unless the context indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, and components thereof.

Bidding is an offer to set a price tag by an individual or business for a product or service or a demand that something be done. In the context of auctions, the price offers a business or individual is willing to pay is called a bid.

There are many sites for selling used products, but all of them are missing an important concept of ‘open and hidden’ bid, displaying and hiding the bid prices based on seller and as well the buyer's choice to show/hide the bid values, therefor to instigate the buyers to guess and increase the bid.

When a seller posts an item to sell, many buyers post their bid in their relevant chat window. Then seller has to see each chat window and has to note down which buyer has posted highest bid amount. This is a manual task. Sometimes more than 500 buyers might send bids. Suppose if seller could not see all the chat windows, then seller may miss the highest bid amount.

And also, seller can't inform to all the buyers that he received a higher bid amount posted by other buyer. If seller can inform to all buyers, then buyers may increase the bid amount and a possibility for a highest bid for the product is posted. If a buyer bids an amount, other buyers may bid less or greater amount in the hidden mode of bidding.

Therefore, there is a need improved methods and systems for selling products with open and hidden bids that address the above and other problems with conventional systems and methods. The above and other needs are addressed by the exemplary embodiments of the present invention, which provide an improved online bidding system and method for buyers to purchase products.

According to an exemplary embodiment of the present invention, an e-commerce system for selling products with open and hidden bids is disclosed. The system comprises a web server to which sellers and buyers makes an access, thus performing access management. The system also comprises a database storing data of functions required for bidding of products, and thereafter concluding a sale. The system further comprises an application server to establish functions for the bidding by using the stored data.

In accordance with the exemplary embodiment of the present invention, the system is configured to receive products for bidding from the sellers in open and/or hidden mode.

In accordance with the exemplary embodiment of the present invention, the system is configured to display products received from the sellers for buyers to place bids in open and/or hidden mode, wherein the open bid amounts from buyers will be made visible to all the buyers participating in the bid, and hidden bid amounts are not visible to other buyers.

In accordance with the exemplary embodiment of the present invention, the system is configured to allow the seller to initiate a final call communicating the highest bid amount received so far from both open and hidden bids received, so that the buyers are allowed to increase their bid value before bid close.

In accordance with the exemplary embodiment of the present invention, the buyers compete for a predetermined time established by the seller.

In accordance with the exemplary embodiment of the present invention, the system receives data from the seller for his listed product, the data includes product description and a bid evaluation data including a desired price and proximity to a location.

In accordance with the exemplary embodiment of the present invention, the system determines one winning bid at the bidding close based on the matching desired price and proximity.

In accordance with the exemplary embodiment of the present invention, the system contains multiple bid pages hosting a plurality of bids, wherein each bid page comprises at least one bid, and redirects to a sale completion page.

In accordance with the exemplary embodiment of the present invention, the bid pages comprises information about individual bids comprising at least one of photographs, maps, government reports, tax information, environmental reports, financing and other information related to sale of the product listed.

In accordance with the exemplary embodiment of the present invention, a time duration for bid closer is allowed to be configured by the seller along with his ‘final call’, and the system allows:
auto generation of bid user an ‘alias name’ for avoiding syndication between buyers; and
displays open and hidden bids “Before Final Call” and “After Final Call”.

In accordance with the exemplary embodiment of the present invention, the system emails information regarding bids in progress to the buyers participated in the bid, wherein the said information comprises highest bid information, bid deadline information, and other information relevant to said bid.

In accordance with the exemplary embodiment of the present invention, updating of prices of a product is based on the extent to which the quantities bid, summed over all bidders, exceed the quantities available in the bidding.

According to another exemplary embodiment of the present invention, a method of selling products with open and hidden bids on an e-commerce system is disclosed.

In accordance with the exemplary embodiment of the present invention, the method comprises a step of providing a web server to which sellers and buyers makes an access, thus performing access management. The method comprises another step of providing a database for storing data of functions required for bidding of products, and thereafter concluding a sale. The method comprises one more step of providing an application server to establish functions for the bidding by using the stored data. The method comprises yet another step of receiving products for bidding from the sellers in open and/or hidden mode.

In accordance with the exemplary embodiment of the present invention, the method comprises another step of displaying products received from the sellers for buyers to place bids in open and/or hidden mode, wherein the open bid amounts from buyers will be made visible to all the buyers participating in the bid, and hidden bid amounts are not visible to other buyers.

In accordance with the exemplary embodiment of the present invention, the method comprises another step of allowing the seller to initiate a final call communicating the highest bid amount received so far from both open and hidden bids received, so that the buyers are allowed to increase their bid value before bid close.

In accordance with the exemplary embodiment of the present invention, the system enables the buyer to post a bid either in open or hidden, wherein the open bid amount is made visible to all buyers, and the hidden bid amount is made not visible to any other buyers. If a buyer posts a hidden bid, then other buyers have to guess that amount, and then has to post a higher bid amount.

In accordance with the exemplary embodiment of the present invention, the system enables the seller to initiate a final call, which informs all the buyers with a mobile message with highest bid amount posted. If any buyers are interested to post higher than that bid amount, they can bid before closing the deal.

In accordance with the exemplary embodiment of the present invention, the system is configured to save valuable time of sellers and buyers. If a buyer come to know that a product selling at a particular time, he can spend little bit higher amount than what it is being selling. In accordance with the exemplary embodiment of the present invention, the system revolutionises selling and buying process. It changes entire supply chain cycle. Where demand exists, the present system is designed to exist.

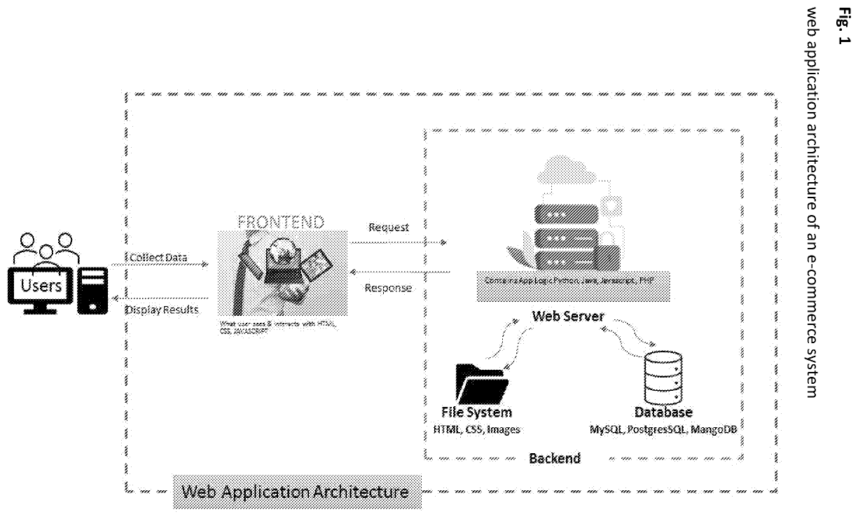

Now Referring to FIGS. 1-14, FIG. 1 discloses web application architecture of an e-commerce system for selling products, wherein a buyer can place a bid either in open or hidden mode. The system comprises a web server to which sellers and buyers makes an access, thus performing access management. The system also comprises a database storing data of functions required for bidding of products, and thereafter concluding a sale. The system further comprises an application server to establish functions for the bidding by using the stored data.

FIG. 1a illustrates a block diagram depicting buyers place their bids either in open or hidden for a product/service. The system is configured to receive products for bidding from the sellers in open and/or hidden mode.

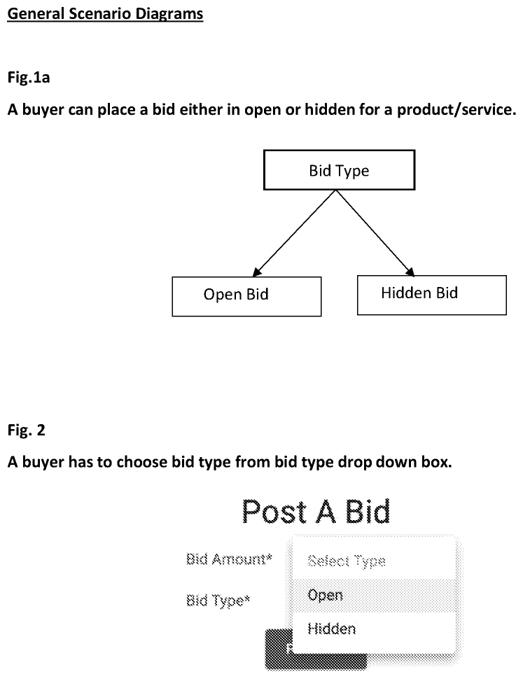

FIG. 2 illustrates a buyer choosing bid type from bid type drop down box. The system is configured to display products received from the sellers for buyers to place bids in open and/or hidden mode, wherein the open bid amounts from buyers will be made visible to all the buyers participating in the bid, and hidden bid amounts are not visible to other buyers.

The system enables the buyer to post a bid either in open or hidden, wherein the open bid amount is made visible to all buyers, and the hidden bid amount is made not visible to any other buyers. If a buyer posts a hidden bid, then other buyers have to guess that amount, and then have to post a higher bid amount.

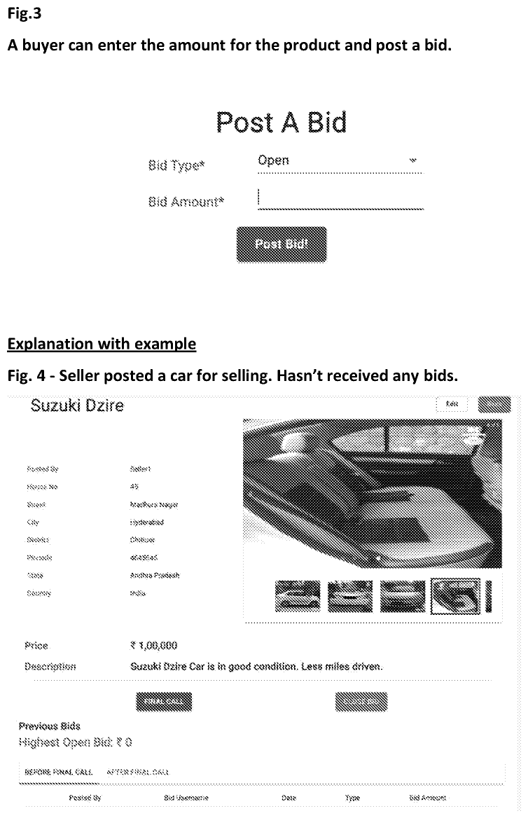

FIG. 3 illustrates buyer can enter an amount for the product and post a bid. If all bids are open, buyer try to increase the bid amount. If some of the bidders bid in hidden mode, the next bidder has to guess the previous user bidden amount, and has to add some more to that amount and has to place that bid.

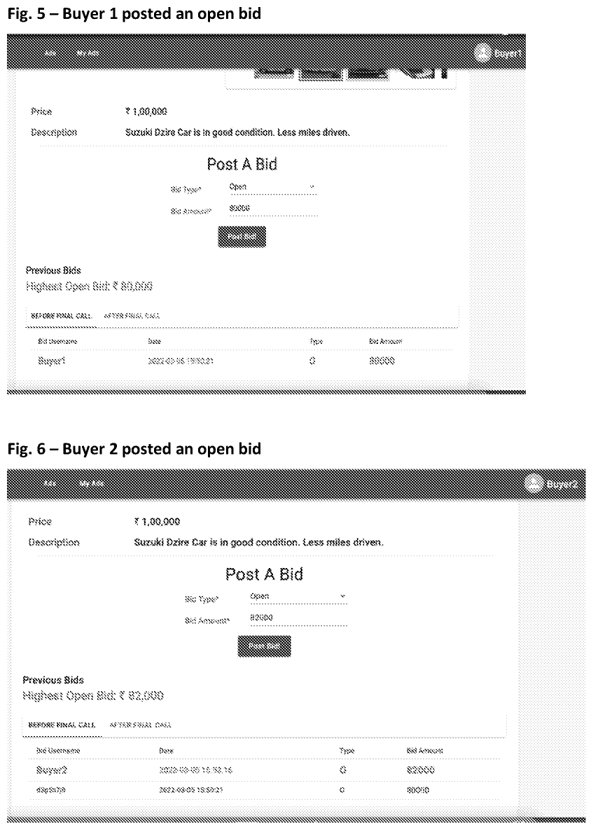

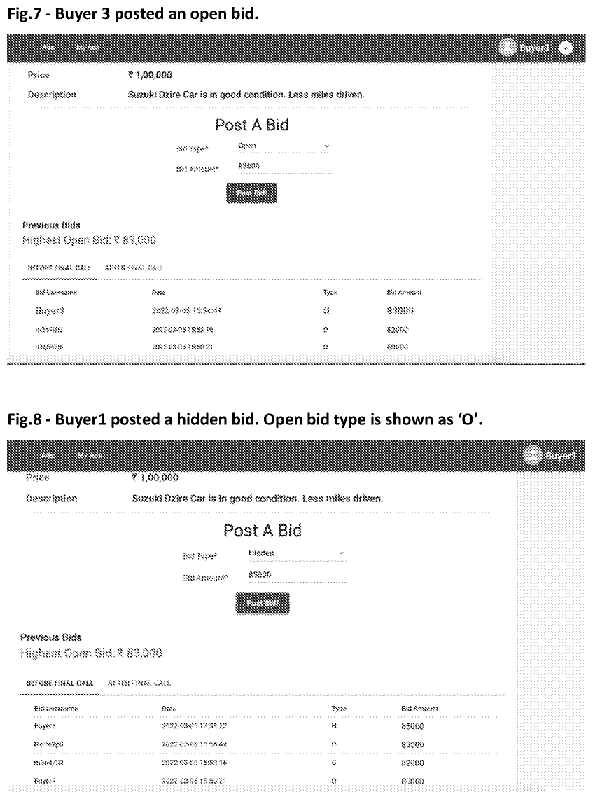

FIG. 4 illustrates a scenario where a seller offers a car to sell at 1,00,000 and he hasn't received any bids yet. FIG. 5 illustrates buyer 1 initiates an open bid. FIG. 6 illustrates buyer 2 initiates an open bid as well. FIG. 7 illustrates buyer 3 also continues with an open bid.

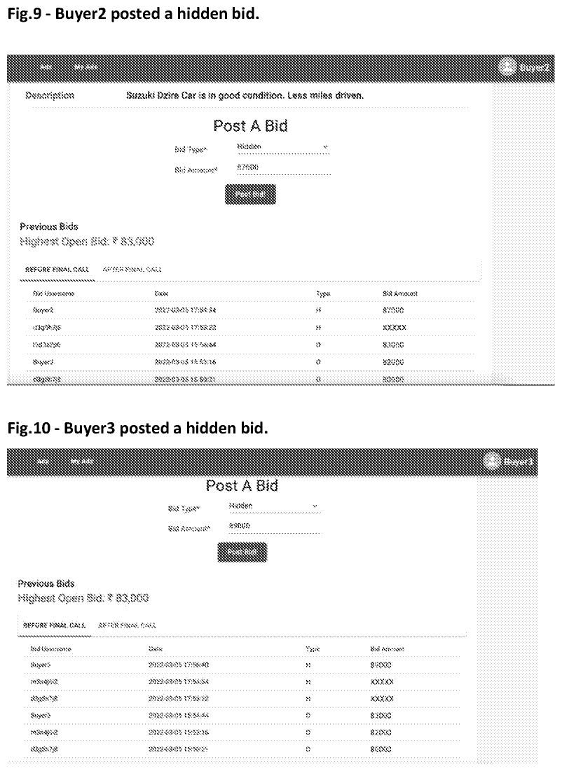

FIG. 8 illustrates buyer 1 proceeds with a hidden bid in continuation to the bids. FIG. 9 illustrates the systems component where the buyer 2 also posts a hidden bid. FIG. 10 illustrates the systems component where buyer 3 as well posts a hidden bid in continuation to buyer 1 and buyer 2's hidden bids.

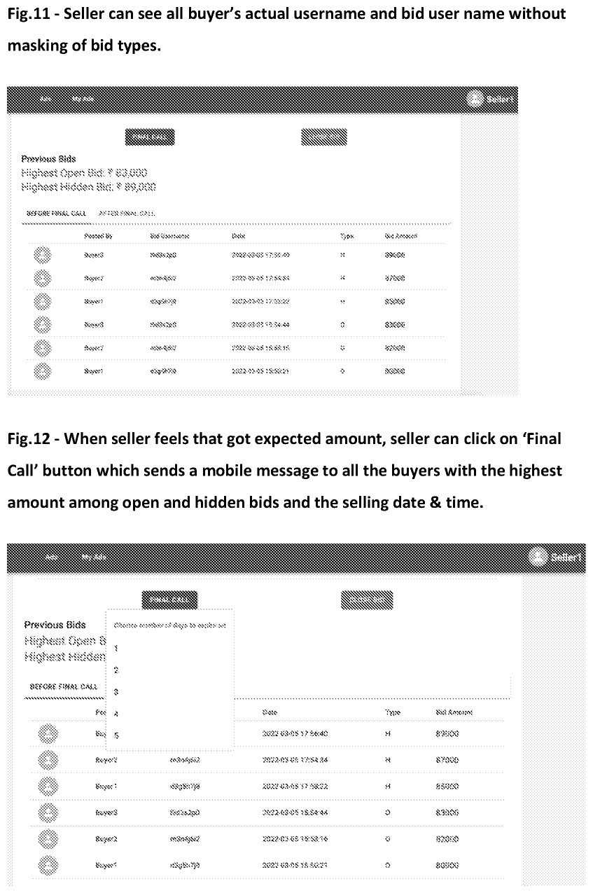

FIG. 11 illustrates the systems component where the seller can see all buyer's actual usernames and bid usernames without masking of bid types. FIG. 12 illustrates the systems component where seller initiates a ‘Final Call’ on receiving an expected amount, where a mobile message to all the buyers is sent so that interested buyers may send final bids.

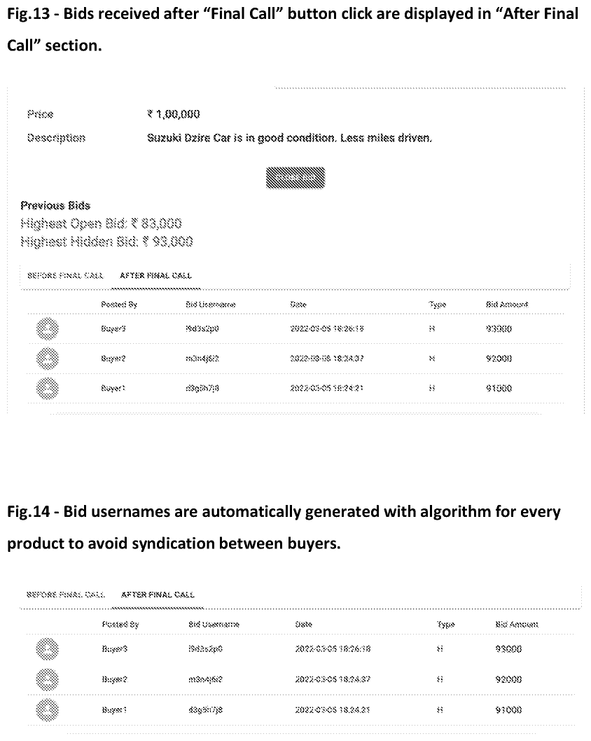

FIG. 13 illustrates the systems component displaying “After Final Call” screen with final call bids. FIG. 14 illustrates the systems component where bid usernames are automatically generated with algorithm for every product to avoid syndication between buyers.

The system is configured to allow the seller to initiate a final call communicating the highest bid amount received so far from both open and hidden bids received, so that the buyers are allowed to increase their bid value before bid close.

The buyers compete for a predetermined time established by the seller.

The system receives data from the seller for his listed product the data includes product description and a bid evaluation data including a desired price and proximity to a location.

The system determines one winning bid at the bidding close based on the matching desired price and proximity.

The system enables the seller to initiate a final call, which informs all the buyers with a mobile message with highest bid amount posted. If any buyers are interested to post higher than that bid amount, they can bid before closing the deal.

Uses of the System in Other Scenarios:

People negotiates while buying a product or paying for a service. Open hidden concept can be used in the below scenarios.

Auto Rikshaw/Cab Booking

In many countries auto rikshaw/cab services are used and there is a bargain of price prior to taking a ride. Based on the location requested by a customer, the auto rikshaw driver quotes a particular price and the ride takes place if both of them agree on a price.

The system is configured for accepting auto rikshaw/cab bookings, wherein customer/passenger is allowed to post an open/hidden bid with a bid price. The drivers can accept the offer to bid their price. Passenger can choose and travel with auto driver who quotes lowest bid.

Farmers

Farmers can sell their produce to distributors. Distributors can sell their products to retailers. The system is configured to receive details of an agriculture produce, wherein the details includes an item description and bid evaluation information including at least a desired price and proximity to a predetermined location.

The system stores the details in the database; receives bid data generated in response to the details, the bid details including bid item information generated in response to the item description of the requested item and bid evaluation information, the system determines at least one winning bid at auction close based on the bid details matching desired price and proximity.

Freelancing

Service seekers post their requirements in freelancing sites. Buyers and as well sellers has to spend lot of time explaining the requirement and to receive a cost quote and convert it into sale. The system is configured to receive details of a freelance work, wherein the details include the service description, and bid evaluation information including at least a desired price, milestones, deliverables, and a fixed time.

The system stores the details in the database; receives bid data generated in response to the details, the bid details including bid item information generated in response to the service description of the requested work, to determine at least one winning bid at auction close based on the bid details matching desired price and proximity.

Bus/Train/Airlines

At times there will be heavy demand for bus, train, airline ticket bookings. Buyers and sellers both look for better price. Buyers and as well sellers has to spend lot of time to receive a price they are looking for. The system is configured to receive details of tickets for sale, wherein the details include the trip information, and bid evaluation information including at least a desired price, amenities, travel time, pickup and drop information.

The system stores the details in the database; receives bid data generated in response to the details, the bid details including bid item information generated in response to the travel description of the trip, to determine at least one winning bid at auction close based on the bid details matching desired price and proximity.

Stake Sell

Many start-ups want to raise fund to extend their operations by diluting their share in the product. The system enables the start-ups to post their bid of offering stake in the company in open and/or hidden bid process. The system is configured to receive details of the offer, wherein the details include the company details, and stake being offered for sale, including at least a desired price, return on investment, exit plan, etc.

The system stores the details in the database; receives bid data generated in response to the details, the bid details including bid item information generated in response to the description of the offer, to determine at least one winning bid at auction close based on the bid details matching desired price and proximity.

Sell Movies to OTT Platforms

Offering movies to OTT platforms by producers is not been tried one-commerce. The system enables the movie makers to post their bid in open and/or hidden bid process to get better price. The system is configured to receive details of the offer, wherein the details include the film details, and type of offer, including at least a desired price, time duration, exclusivity, etc.

The system stores the details in the database; receives bid data generated in response to the details, the bid details including bid item information generated in response to the description of the offer, to determine at least one winning bid at auction close based on the bid details matching desired price and proximity.

Bank Auctions

Banks auctions the mortgaged/pledged immovable and movable properties on obtaining a decree execution from a court of law. The system enables the banks to post their bid in open and/or hidden bids to get a desired price. The system is configured to receive details of the offer, wherein the details include the property details, and type of offer, including at least a desired price, time duration, conditions of sale, etc.

The system stores the details in the database; receives bid data generated in response to the details, the bid details including bid item information generated in response to the description of the offer, to determine at least one winning bid at auction close based on the bid details matching desired price and proximity.

Hotel/Resorts and Other Holiday Destinations

In many situations hotels/resorts and other holiday destinations have huge demand at times. The system enables the hotels to post their bid in open and/or hidden mode to get a desired price. The system is configured to receive details of the offer, wherein the details include the property details, and type of offer, including at least a desired price, time duration, conditions of booking, etc.

The system stores the details in the database; receives bid data generated in response to the details, the bid details including bid item information generated in response to the description of the offer, to determine at least one winning bid at auction close based on the bid details matching desired price and proximity.

The system is configured to save valuable time of sellers and buyers. If a buyer come to know that a product selling at a particular time, he can spend little bit higher amount than what it is being selling. In accordance with the exemplary embodiment of the present invention, the system revolutionises selling and buying process. It changes entire supply chain cycle. Where demand exists, the present system is designed to exist.

I claim:

1. An e-commerce system for selling products with open and hidden bids, wherein the system comprises:
a web server to which sellers and buyers makes an access, thus performing access management;
a database storing data of functions required for bidding of products, and thereafter concluding a sale;
an application server to establish functions for the bidding by using the stored data;
Characterized in that
the system is configured to receive products and/services for bidding from the sellers in open and/or hidden mode;
the system is configured to display products received from the sellers for buyers to place bids in open and/or hidden mode, wherein the open bid amounts from buyers will be made visible to all the buyers participating in the bid, and hidden bid amounts are not visible to other buyers; and
the system is configured to allow the seller to initiate a final call communicating the highest bid amount received so far from both open and hidden bids received, so that the buyers are allowed to increase their bid value before bid close.

2. The system as claimed in claim 1, wherein the buyers compete for a predetermined time established by the seller.

3. The system as claimed in claim 1, wherein the system receives data from the seller for his listed product, the data includes product description and a bid evaluation data including a desired price and proximity to a location.

4. The system as claimed in claim 1, wherein the system determines one winning bid at the bidding close based on the matching desired price and proximity.

5. The system as claimed in claim 1, wherein the system contains multiple bid pages hosting a plurality of bids, wherein each bid page comprises at least one bid, and redirects to a sale completion page.

6. The system as claimed in claim 1, wherein the bid pages comprises information about individual bids comprising at least one of photographs, maps, government reports, tax information, environmental reports, financing and other information related to sale of the product listed.

7. The system as claimed in claim 1, wherein a time duration for bid closer is allowed to be configured by the seller along with his ‘final call’, and the system allows:
a. auto generation of bid user an ‘alias name’ for avoiding syndication between buyers; and
b. displays open and hidden bids “Before Final Call” and “After Final Call”.

8. The system as claimed in claim 1, wherein said system emails information regarding bids in progress to the buyers participated in the bid, wherein the said information comprises highest bid information, bid deadline information, and other information relevant to said bid.

9. The system as claimed in claim 1, wherein updating of prices of a product is based on the extent to which the quantities bid, summed over all bidders, exceed the quantities available in the bidding.

10. A method of selling products with open and hidden bids on an e-commerce system, wherein the method comprises steps of:
providing a web server to which sellers and buyers makes an access, thus performing access management;
providing a database for storing data of functions required for bidding of products, and thereafter concluding a sale;
providing an application server to establish functions for the bidding by using the stored data;
receiving products for bidding from the sellers in open and/or hidden mode;
displaying products received from the sellers for buyers to place bids in open and/or hidden mode, wherein the open bid amounts from buyers will be made visible to all the buyers participating in the bid, and hidden bid amounts are not visible to other buyers; and
allowing the seller to initiate a final call communicating the highest bid amount received so far from both open and hidden bids received, so that the buyers are allowed to increase their bid value before bid close.
